(19) United States
(12) Patent Application Publication
(10) Pub. No.: US 2018/0276589 A1
(43) Pub. Date: Sep. 27, 2018

(54) ADVANCED OPTICAL LENS JOB ORDER ROUTING

(71) Applicant: Essilor International, Charenton-le-Pont (FR)

(72) Inventor: Michael A. FILIPOVICH, Dallas, TX (US)

(73) Assignee: Essilor International, Charenton-le-Pont (FR)

(21) Appl. No.: 15/570,697

(22) PCT Filed: Jun. 2, 2015
(86) PCT No.: PCT/IB2015/001058

§ 371 Date: Oct. 30, 2017

(51) Int. Cl. G06Q 10/06; G06Q 50/04

(52) U.S. Cl. CPC G06Q 10/06316; G06Q 50/04

(57) ABSTRACT

The disclosed embodiments include a system and method for monitoring the status of optical lens orders. In one embodiment, the system includes memory for storing computer executable instructions and data; and a processor for executing the computer executable instructions. For instance, in one embodiment, the computer executable instructions comprise instructions for, in no particular order, associating a processing tray with an optical lens order; receiving input indicating that the processing tray is at a first processing station; electronically placing the processing tray in a sequence in one of a plurality of processing tray stacks, wherein the sequence emulates a physical stacking sequence of the plurality of processing tray stacks at the first processing station; and displaying the plurality of processing tray stacks in the sequence on a display. In addition, the system may be configured to execute one or more additional instructions as disclosed herein.

### BACKGROUND

The present disclosure relates generally to systems and methods for monitoring the processing of an optical lens job.

Today, production operators in optical labs often have to look at the paper work ticket that is printed and placed into a tray accompanying a lens order. Some labs print different color pages or put specific order types in a given tray color. For example, a job that is to be coated with hard coating might go in a yellow tray or its work ticket printed on yellow paper. Jobs that need to go out in 24 hours might be printed on purple paper or some other color.

There are codes or station lists printed on some work tickets that help operators know where to take trays throughout the production process. Most often this is manually done by operators looking at the individual work tickets in the trays. This process typically takes some level of training to understand the clues to use in deciding the direction of the tray from any given point in production (e.g. trays with polycarbonate lenses might go to certain edger, whereas trays with high index lenses may go to another edger).

For jobs that are rush-orders or jobs that have fallen late, the labs often use “rush” stickers that are placed on the trays by an operator or expeditor. Some labs put clips on the trays to prevent other trays from being stacked on them or even tennis balls in the trays to accomplish the same thing. This physical indicator on or in a tray makes it more likely that the job will move through production ahead of other jobs because they won't get buried under other jobs in the area.

Larger labs pay the expense to employ dedicated expeditors that regularly run reports or queries looking for late jobs or jobs at risk of being late. Then, a person must find those jobs in production that are late or at risk of being late and add a clip or sticker or tennis ball to help the production operators know that these specific jobs are now high priority.

### BRIEF SUMMARY OF THE DISCLOSED EMBODIMENTS

The disclosed embodiments provide better guidance during the lens production process than what is currently being used in today's optical lens facilities. For example, the disclosed embodiments provide better guidance as to the next destination for an order from any given production point. In addition, the disclosed embodiments provide better visibility to the contracted or expected completion date of each order to insure that customer expectations are being met. For example, efficiencies that can be gained using the disclosed embodiments include, but are not limited to, identifying which orders should be first, where the order should move next, and which orders to group together when moving more than one order from one location to another location during the lens production process.

In addition, the disclosed embodiments provide visibility to changes in the expected delivery date caused by a delay in processing, a missed order, or from a change in an agreement between an optician and customer service representative that occurs while a job is in production. For example, an optician might call on Wednesday morning to request that an order be shipped by Thursday to allow a patient to get her glasses before a wedding on the weekend even though that order might typically be scheduled to ship on Friday afternoon.

In one embodiment, the system operates on a network and provides an online tool that enables monitoring and displaying of the status of optical lens orders to remote terminals or displays. In other embodiments, the system may be run locally for providing the monitoring and displaying of the status of optical lens orders. For example, in some embodiments, the disclosed embodiments may be incorporated within a software application that is executed on a local computer system, laptop, tablet, smart phone, or other electronic devices for enabling the monitoring and displaying of the status of optical lens orders.

As one example, specific embodiments disclosed herein include a system that is configured to monitor the status of optical lens orders. In one embodiment, the system includes memory for storing computer executable instructions and data; and a processor for executing the computer executable instructions. For instance, in one embodiment, the computer executable instructions comprise instructions for, in no particular order, associating a processing tray with an optical lens order; receiving input indicating that the processing tray is at a first processing station; electronically placing the processing tray in a sequence in one of a plurality of processing tray stacks, wherein the sequence emulates a physical stacking sequence of the plurality of processing tray stacks at the first processing station; and displaying the plurality of processing tray stacks in the sequence on a display. In addition, the system may be configured to execute one or more additional instructions as disclosed herein.

The disclosed embodiments may also include a computer implemented method and a computer-readable storage media having stored thereon computer-executable instructions that may include, but not limited to, one or more of the instructions that when executed by a processor of a system, enables the system to monitor and display the status of optical lens orders in accordance with the disclosed embodiments.

Additional details of the disclosed embodiments are provided below in the detailed description and corresponding drawings.

### BRIEF DESCRIPTION OF THE DRAWINGS

Illustrative embodiments of the present invention are described in detail below with reference to the attached drawing figures, which are incorporated by reference herein, and wherein:

FIG. 1 illustrates a system for monitoring and displaying the status of optical lens orders in accordance with one embodiment;

FIG. 2 is a block diagram conceptually illustrating certain components of an advanced optical lens job order routing application in accordance with one embodiment.

FIG. 3 is a flowchart illustrating a process for monitoring and displaying the status of optical lens orders in accordance with one embodiment;

FIG. 3A is an image illustrating a user scanning a bar code of a processing tray that is associated with an optical lens order in accordance with one embodiment;

FIG. 3B is an image illustrating a user physically stacking a plurality of processing trays that are associated with optical lens orders in accordance with one embodiment;

FIG. 4 is a flowchart illustrating a process for updating the status of optical lens orders in accordance with one embodiment;

FIG. 5 is a flowchart illustrating another process for updating the status of optical lens orders in accordance with one embodiment;

FIG. 6 is a flowchart providing a simple illustration of a user interface that illustrates the process of adding and removing processing trays associated with optical lens orders in accordance with one embodiment;

FIG. 7A is an image illustrating a user interface for monitoring and displaying the status of optical lens orders in accordance with one embodiment; and

FIG. 7B is another image illustrating a user interface for monitoring and displaying the status of optical lens orders in accordance with one embodiment.

The illustrated figures are only exemplary and are not intended to assert or imply any limitation with regard to the environment, architecture, design, or process in which different embodiments may be implemented.

### DETAILED DESCRIPTION

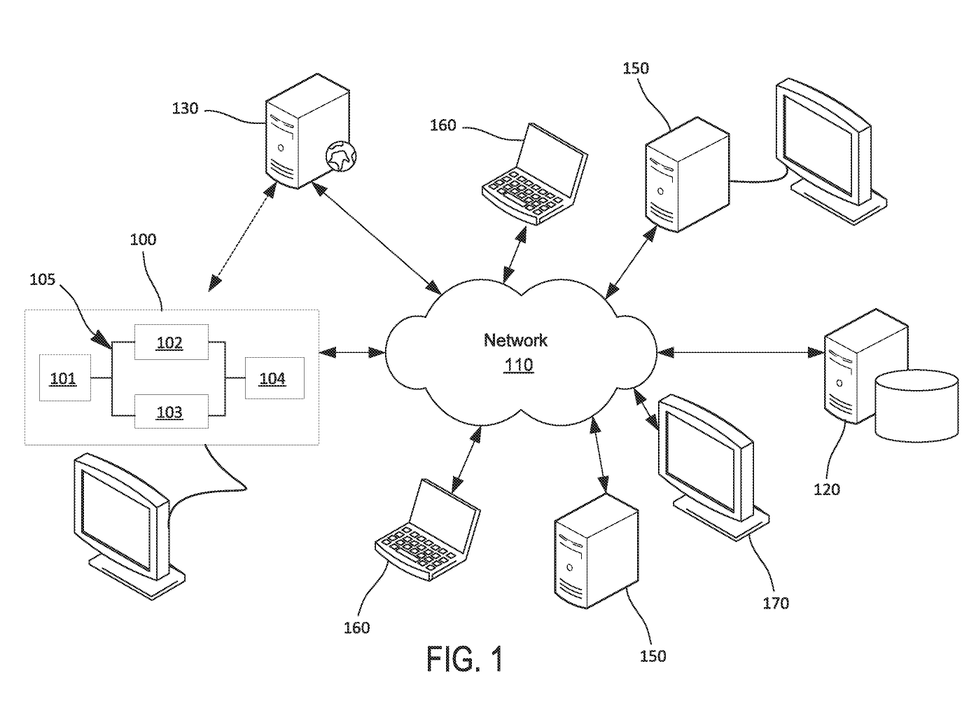

FIG. 1 illustrates a system for monitoring and displaying the status of optical lens orders in accordance with one embodiment. For example, in the depicted embodiment, the system 100 may communicate over a communication network 110 with a number of other devices including, but not limited to, a database 120, a web server 130, and one or more client devices 160.

The communication network 110 may be any type of wired or wireless connection, which may include one or more public or private networks or some combination thereof, such as the Internet, an intranet, a mobile cellular or data network, or any other network operable to transmit data to and from the system 100.

In one embodiment, the system 100 comprises components including one or more processors 101, a computer-readable storage media 102, an input/output interface 103, and a network interface 104. Each of the components of the system 100 communicates via a systems bus 105 that transfers data between the components. The processors 101 may be of any type and having any number of cores. The processors 101 are configured to process data and execute computer-executable instructions. These instructions may include, but are not limited to, machine code instructions, byte code for a software interpreter, object code, and source code in a high-level programming language.

Data and computer-executable instructions are stored in the computer-readable storage media 102. The computer-readable storage media 102 may be any appropriate memory device or computer storage media, such as, but not limited to, a hard disk drive, random access memory, read only memory, electrically erasable programmable read-only memory, flash memory or other memory technology, compact disc-read only memory, digital versatile disks or other optical disk storage, magnetic cassettes, magnetic tape, magnetic disk storage or other magnetic storage devices. In some embodiments, the data and executable instructions may be stored on a component or device that is external to the system 100 such as, but not limited to, being stored on a network device or on an external memory drive.

The input/output (I/O) interface 103 comprises an input interface for receiving user input or data from one or more peripheral devices. For example, the I/O interface 103 may receive user input or data from one or more input devices such as, but not limited to, a keyboard, mouse, touch screen, microphone, scanner, and/or a camera. The I/O interface 103 also comprises an output interface for outputting information to one or more device or component associated with the system 100. For example, the I/O interface 103 may output data or other information to a display device for displaying information to a user, another system, and/or to a printer.

The network interface 104 may include one or more wired or wireless interfaces such as, for example, an Ethernet port or a wireless transceiver for enabling the system 100 to send and receive data over the network 110. The network interface 104 is not limited to any particular communication protocol or hardware interface.

The database 120 may contain information provided and/or maintained by a single entity (e.g., by a provider of the system 100) or by a combination of entities including one or more independent third parties. Still, in certain embodiments, the system 100 may store all data in a local data storage unit or database to eliminate the need to access the network 110 to retrieve the data.

In addition, the network interface 104 may also enable the system 100 to communicate with other devices over the network 110. For example, in certain embodiments, the system 100 may communicate with a web server 130 for providing the services disclosed herein as a web application or website (also commonly referred to as a webpage or web portal) to one or more clients 160. For example, in some embodiments, the system 100 may operate as a back end server that processes and provides all the services described herein, while the web server 130 provides the front end services of gathering and displaying information using one or more user interfaces/webpages. Typically, the user may access the webpage or web application using a web browser application. Still, in certain embodiments, the system 100 may provide services to the one or more clients 160 directly without the use of the web server 130 or other intermediate servers.

Additionally, in some embodiments, the system 100 may be a client or end user device such as but not limited to a personal computer, mobile computer, laptop, smart phone, personal digital assistant, or any other computing device that has locally stored computer executable instructions for monitoring and displaying the status of optical lens orders in accordance with the embodiments disclosed herein. For instance, alternatively to or in addition to providing the embodiments disclosed herein as an online tool or application, in certain embodiments, the embodiments described herein may be locally installed on a client/end-user computing device as a software application or mobile application.

Additionally, the system 100 may communicate either locally or over the network 110 with any number of other machines/devices 150 such as, but not limited to an email server, accounting server, and a reporting server. For example, in some embodiments, the system 100 may be further configured to communicate with an accounting server for billing a client or an insurance company for a lens order. Still, in some embodiments, the system may simply transmit information to a remote monitor 170 for displaying on the remote monitor 170. In some embodiments, the remote monitor 170 may be a dummy device that is not able to perform any functions other than displaying the received information. In other embodiments, the remote monitor 170 may include built-in processing capabilities that enable the user to perform one or more features as described herein.

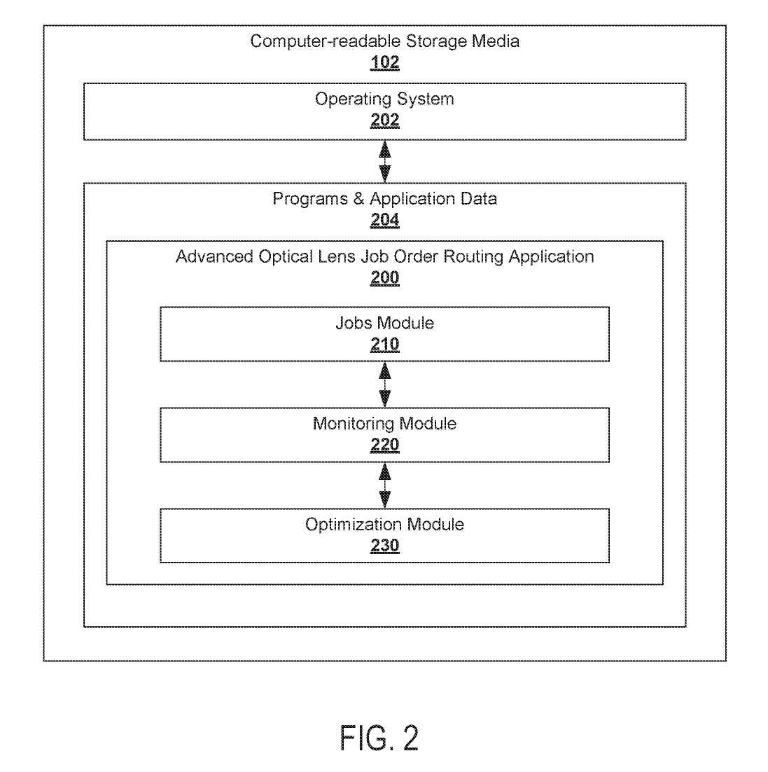

FIG. 2 is a block diagram conceptually illustrating certain components of an advanced optical lens job order routing application 200 in accordance with one embodiment. The advanced optical lens job order routing application 200 comprises of data and computer executable instructions stored in the computer-readable storage media 102, such as main memory or a hard drive, that when executed performs the processes disclosed herein. In certain embodiments, the computer-readable storage 102 media may also store data and computer executable instructions associated with an operating system 202 and/or one or more programs/applications 204. Still, in certain embodiments, the advanced optical lens job order routing application 200 may be a component of a larger software application.

In the depicted embodiment, the advanced optical lens job order routing application 200 includes examples of the types of classes, objects, or software modules that may be employed to perform the processes disclosed herein. For instance, in one embodiment, the advanced optical lens job order routing application 200 may include a jobs module 210, a monitoring module 220, and an optimization module 230.

In one embodiment, the jobs module 210 includes data and executable instructions for maintaining lens order information. For example, in one embodiment, the jobs module 210 may include instructions for retrieving or receiving lens order information from a plurality of sources such as, but not limited to, a lens order database, an optical service provider system, and by user input. For example, in one embodiment, the system 100 may query or communicate with one or more private or public database 120 that contains lens order data such as prescription, material, special coatings, date ordered, date requested, etc. In addition, in some embodiments, the user may input information from lens orders received through faxed orders, email, or by telephone.

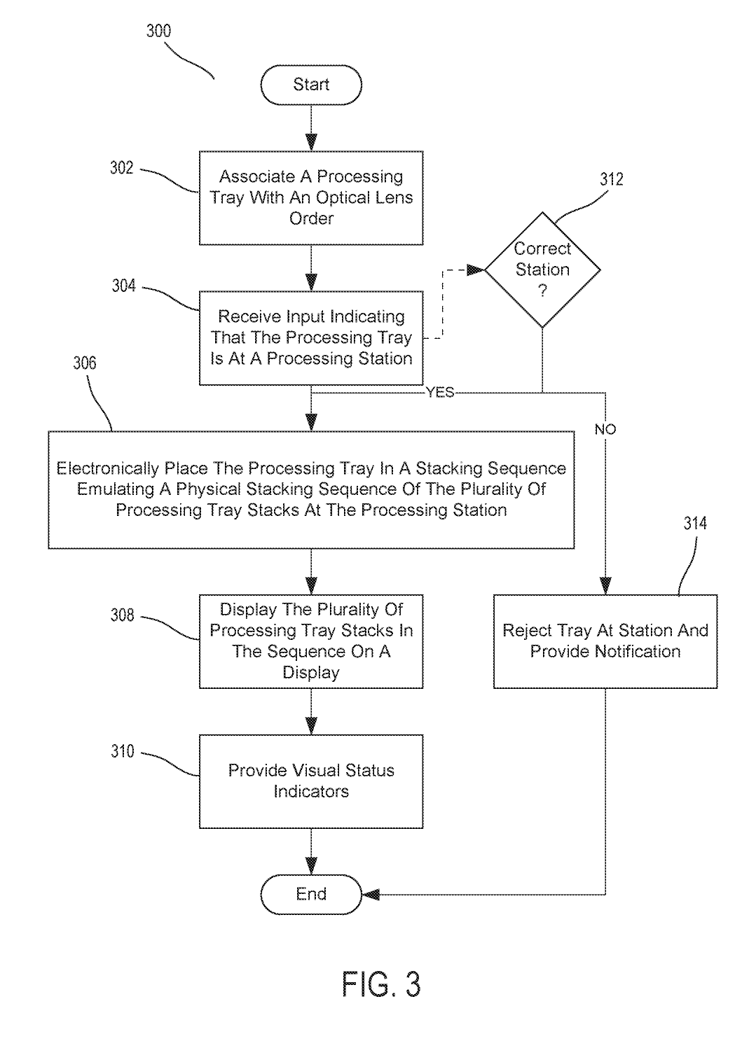

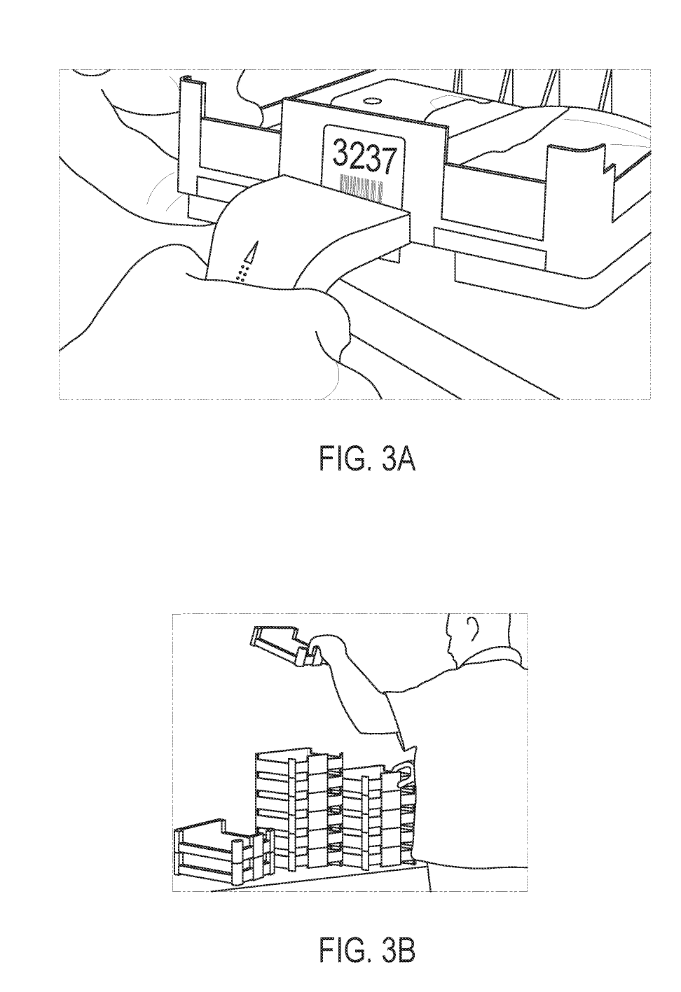

The jobs module 210 may also include instructions for storing, retrieving, and correlating barcode information or other identifying information corresponding to processing trays used for holding and transporting lens during the process of making a lens in accordance with a lens order. The term processing tray as used herein does not imply the use of any particular type, brand, color, size, and shape of tray. In one embodiment, the processing trays may have affixed barcode labels. As an example, as illustrated in FIG. 3A, a user may use a barcode scanner such for associating a lens order with a particular processing tray, and for indicating that a particular processing tray is at a particular processing station. Alternatively, in some embodiments, the user may manually type in an identifier associated with the processing tray. Still, in some embodiments, automated barcode readers may read the barcode labels affixed to processing trays as the tray is automatically moved from one station to another using an automated track system.

The jobs module 210 may also include instructions for monitoring or receiving updates on lens orders. For example, the jobs module 210 may include instructions for periodically checking for updated information on lens orders such as, but not limited to, a change in prescription, a coating is added or removed, or a requested completion date has changed.

In one embodiment, the monitoring module 220 may include data and executable instructions for creating the initial stacking sequence of the plurality of trays. For example, in one embodiment, the initial stacking sequence is from lower left to upper right, where the lower left tray indicates a first tray that is stacked in the plurality of processing tray stacks. Alternatively, the initial stacking sequence may be from lower right to upper left, where the lower right tray indicates a first tray that is physically stacked in the plurality of processing tray stacks. For example, FIG. 3B is an image illustrating a lab technician physically stacking a plurality of processing trays that are associated with optical lens orders in accordance with one embodiment. The disclosed embodiments may also be employed with an automated stacking system.

In one embodiment, the user may select the desired order of the sequence. In addition, the monitoring module 220 may include data and executable instructions for setting how many trays are in a stack, and a maximum number of stacks that may be located at a particular processing station. These numbers may vary based on the particular processing station. Additionally, in some embodiments, these settings may be adjusted by a user or lab technician.

In certain embodiments, the monitoring module 220 may also include instructions for monitoring for any changes associated with the plurality of processing trays and updating the stacking sequence order of the plurality of processing trays. For example, in one embodiment, the monitoring module 220 may include instructions to periodically, at certain time intervals, determine whether any of the processing trays within the plurality of processing trays has been moved from a particular stack. For instance, in one embodiment, if the monitoring module 220 receives an indication that a particular processing tray, that used to be located within the plurality of processing trays at a first processing station, has been scanned in at another station, the process will update the stacking sequence order of the plurality of processing trays at the first processing station to remove that particular processing tray. In one embodiment, if a processing trays is removed from a given stack to move to another station, that stack is reduced in height, but not replaced with another tray unless it's the last stack in the sequence. Alternatively, in some embodiments, no additional processing trays are added if a processing tray is removed. In other words, in some embodiments, all of the plurality of processing trays is processed at a given station before a new sequence of processing trays are started.

In certain embodiments, the monitoring module 220 may also include instructions for determining whether a processing tray that is scanned in at a particular station belongs at that station. For instance, if a particular processing tray is scanned in at station A, but should be processed next at station D, then, in one embodiment, the monitoring module 220 may also include instructions for rejecting the processing tray at station A and displaying a message indicating the correct processing station for the particular processing tray.

Still, in certain embodiments, the monitoring module 220 may also include instructions for enabling a user to retrieve additional information about a lab order. For instance, in one embodiment, the monitoring module 220 may also include instructions for enabling drop-down menus to expose more information about any given cell that represents a processing tray at the station. For example, in one embodiment, by clicking on a given cell the user can see the next stage and step that are configured for that processing tray. In one embodiment, the user can also see a copy of the production work ticket displayed on the screen or a preliminary copy of the delivery note that shows pricing and bill-to/ship-to addresses etc. that will be printed when the order ships. Other options may also be available. In one embodiment, the options available to a user are configurable by an administrators.

In some embodiments, the optimization module 230 may include data and executable instructions for determining an optimized stacking sequence for a plurality of processing trays. For instance, in one embodiment, instead of simply emulating the physical stacking of trays from left to right, or right to left, the optimization module 230 may determine which processing stray should be stack first, and so on, such that the processing trays are stacked in order of highest priority to lowest priority or by some other grouping to optimize the processing of the lens orders. In one embodiment, this determination is based on statistical data of past processing orders. An advantage of this embodiment is that the lab technician or an automated system can simply process the lens order in accordance with the sequence of the stack. However, this embodiment does not accommodate changes to lens orders such as a change in a requested completion date.

Thus, in some embodiments, the optimization module 230 may also include instructions for providing visual indicators such as, but not limited to, displaying processing trays that correspond to late job orders in a first color, displaying processing trays that correspond to job orders that are at risk of being late in a second color, and displaying processing trays that correspond to job orders that are due today in a third color. In one embodiment, the disclosed embodiments are configurable as to whether to consider promised date, estimated delivery date or both when deciding whether a tray is on time, out today, or late.

Although the use of color is mentioned as a visual indicator, the disclosed embodiments may utilize other types of visual indicators including, but not limited to, increasing the size of certain processing trays, using certain markings, highlights, or alternative shapes to indicate processing trays corresponding to jobs of varying priority.

The optimization module 230 may also include instructions for refreshing the color and border settings based on updated lens order information. For example, a processing tray associated with a lens order that is on-time on Monday at the end of the day might be changed to an accent color on the monitor by Tuesday morning if it needs to go out on Tuesday. Similarly, if a customer requests that a lens order be expedited while in processing, the promised date could change the color status of the tray on the monitor without any operator intervention in production.

Still, in some embodiments, the optimization module 230 may include instructions for grouping a plurality of processing trays that should be processed together as they share a common subsequent processing station. For example, in certain embodiments, a subsequent processing station such as an anti-glare coating processing station may require a certain number of lens orders to be simultaneously processed together. By grouping all lens orders that require this lens treatment together, the process reduces delay and optimizes the overall processing time of lens orders. The grouping may be indicated using a visual indicator such as, but not limited to, a prominent border being displayed around the grouped plurality of processing trays.

In one embodiment, only one grouping of processing trays is displayed at a time. By providing one (and only one) grouping of trays on the monitor with borders around the trays in that grouping and by always including the job that is expected to move first (highest priority among all jobs at the station) in that grouping, it will be simple and visual for an operator to easily see which trays to move first. In alternative embodiments, multiple grouping of processing trays may be depicted at a time. This may enable a lab technician to plan ahead on how to process the plurality of processing trays.

In one embodiment, the optimization module 230 may also include instructions for generating a visual indication of a particular processing tray that should be processed first among the plurality of processing tray stacks. In one embodiment, this first processing tray is the first tray to be processed within an identified group of processing trays. For example, in one embodiment, this processing tray may be the latest of all optical lens orders that have respectively exceeded their expected completion date.

FIG. 3 is a flowchart illustrating a process 300 for monitoring and displaying the status of optical lens orders in accordance with one embodiment. The process begins at step 302 by associating a processing tray with an optical lens order. For example, a user may assign a particular tray to a lens order by manually entering an identifier of a processing tray or scanning a barcode affixed to a processing tray and assigning it to lens order. Another alternative is to insert a work ticket that has identifying information for the lens order sometimes including, but not limited to bar-codes that can be used to identify the order with scanning equipment at work stations or attached to processing devices. For example, in one embodiment, the work ticket is folded and inserted in the tray in such a way that the bar-codes on the paper are exposed in a position where the scanning devices will read the bar-code as the tray passes down a conveyor belt or as an operator scans manually with a bar-code reader. Additionally, in some embodiments, different color trays may be used to distinguish between different lens orders. For example, lens order of a certain material may be associated with a particular color processing tray.

Once a processing tray is associated with an optical lens order, at step 304, the process receives input indicating that the processing tray is at a particular processing station. Again, this may be from a user manually entering information into the system, using a barcode scanner, or through the use of automated scanning system. Still, in certain embodiments, the processing trays may be configured with one or more sensors or microchips that enable the precise location of the processing trays to be automatically determined without any user interaction. The sensors will enable the system to automatically detect when a tray is moved from one location to another.

In one embodiment, the process at step 312, determines whether the processing tray is at the correct processing station. For example, in one embodiment, the system may be configured to determine the optimum processing path for a lens order. Based on this information, the process can determine whether the processing tray is at the correct processing station. In one embodiment, if the process determines that the processing tray is not at the correct processing station, the process at step 314 rejects the processing tray at that station and provides notification to the user. For example, in one embodiment, a pop-up box may be presented to inform the user of the correct processing station. In some embodiments, the process may also create a log file to track errors in the process and may be used to improve the process.

If the process determines that the processing tray is at the correct processing station, the process at step 306 electronically places the processing tray in a stack sequence of processing trays emulating a physical stacking sequence of a plurality of processing tray stacks at the processing station.

At step 308, the process displays the stack sequence of processing trays on a display device. In one embodiment, the process displays and updates the stack sequence of processing trays after every new processing tray is added to the stack sequence. This will enable the user to easily ensure that the physical stacking of the processing trays is in the proper sequence.

The process at step 310 determines and provides the visual status indicators. For example, as previously described, the process may display a set of processing trays in a certain color to indicate that the lens orders associated with these processing trays are late, at risk of being late, needs to be completed today, requires special handling, etc.

The display device may be located locally at the processing station and/or located on a big-screen monitor that enables multiple users within the facility to the progress particular processing stations. There may be as many monitors or display devices running for a given station as desired. Each display device will be updated regularly according to a configurable refresh rate. In some embodiments, a display device may also display the stacks of processing trays located at other stations. This will enable a user to be aware of any bottlenecks or other issues occurring elsewhere in the facility.

In some embodiments, the information may also be displayed remotely. For example, the information may be viewed remotely in a supervisor's office. For instance, a supervisor might keep 4 or 5 different station monitors open all day to see how the team is performing without having to leave his or her office. In some embodiments, the information may also be viewed in another building or city over the network. This could allow supervisors from other production sites to see how busy it is somewhere else in case orders can be reallocated from one location to another. Thus, the disclosed embodiments can provide visibility that they wouldn't otherwise have as to workloads at the other production facilities.

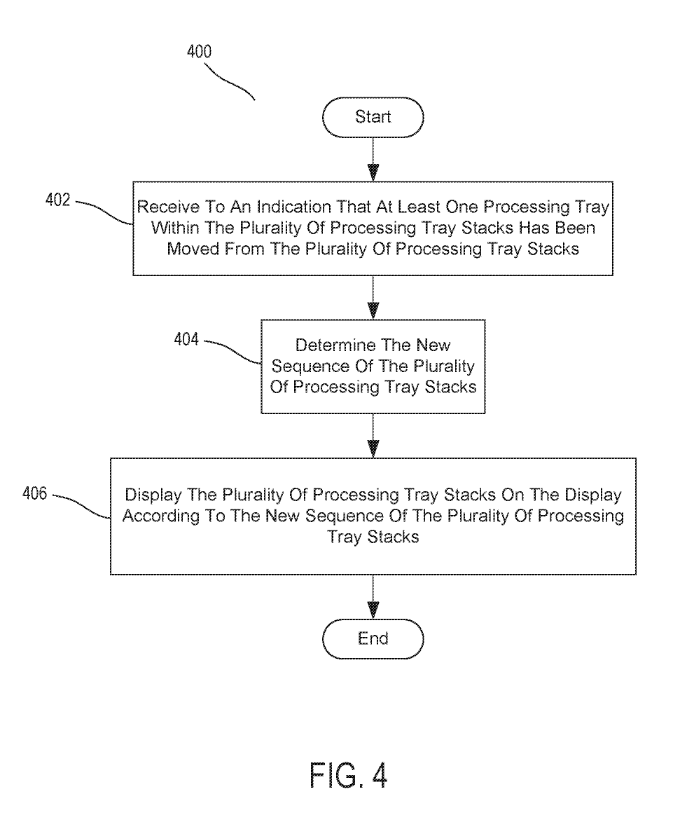

FIG. 4 is a flowchart illustrating a process 400 for updating the status of optical lens orders in accordance with one embodiment. In the depicted embodiment, the process at step 402 receives an indication that at least one processing tray within the plurality of processing tray stacks has been moved from the plurality of processing tray stacks. For example, a user may manually specify removal of a particular processing tray from a station using a barcode scanner or through other forms of user input. In addition, the process may receive an indication that a processing tray has been scanned in at another processing station.

In response, the process at step 404 determines a new stack sequence for the plurality of processing trays at the station. The process at step 406 then updates and displays the new stack sequence for the plurality of processing trays at the station on one or more display devices.

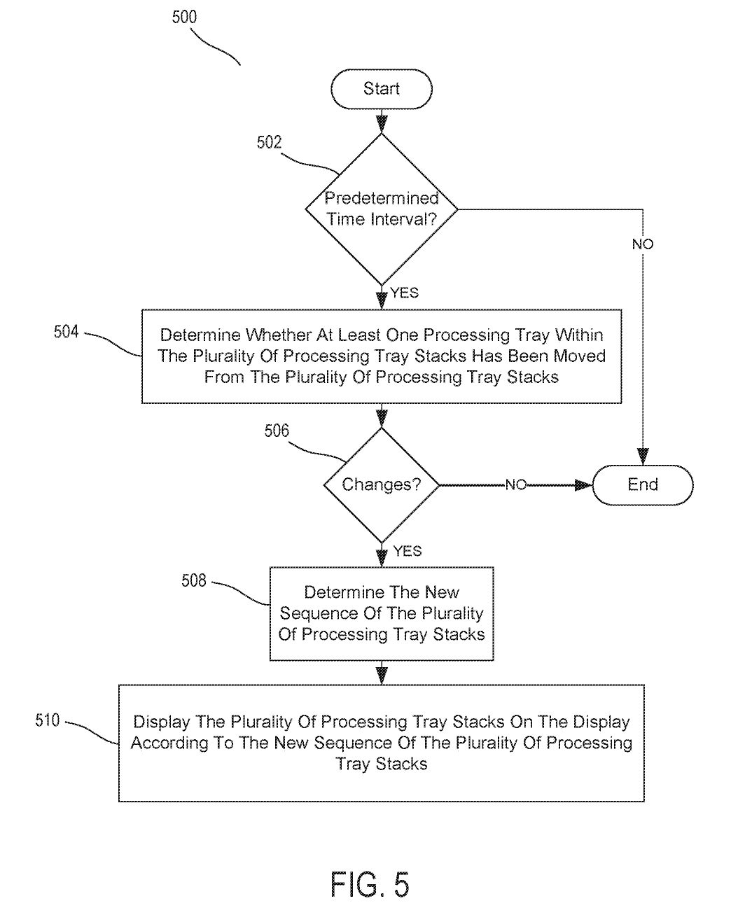

FIG. 5 is a flowchart illustrating another process for updating the status of optical lens orders in accordance with one embodiment. In the depicted embodiment, the process at step 502 determines if a predetermined time interval has lapsed and if so, the process at step 504 determines whether at least one processing tray within the plurality of processing tray stacks of the processing station has been moved. In one embodiment, this determination may be based upon information gathered from other processing stations. For example, if another processing station contains a processing tray that was in the stack sequence of processing tray stacks at a first processing station, the process will remove the processing tray from the stack sequence of processing tray stacks at the first processing station. In some embodiments, the process may request that the user indicate whether any processing trays have been removed from the station.

If the process determines that there are no changes at step 506, the process terminates. However, if there are changes, the process at step 508 determines the new stacking sequence of the plurality of processing trays at the processing station. The process, at step 510, updates and displays the new stacking sequence of the plurality of processing trays at the processing station.

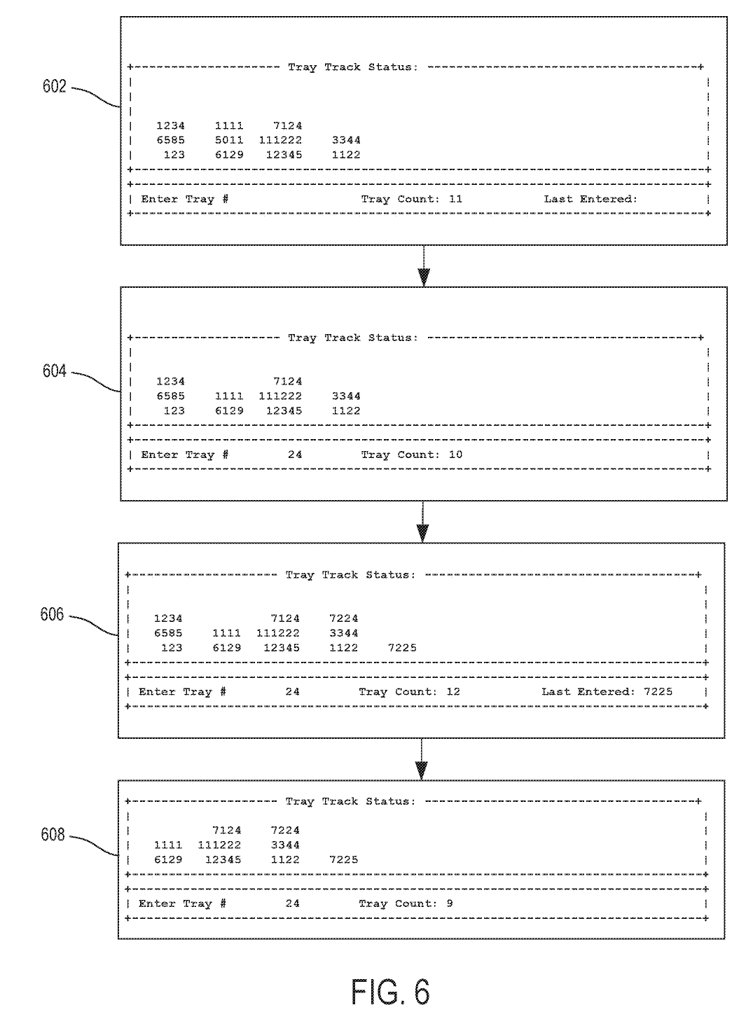

FIG. 6 is a flowchart providing a simple illustration of a user interface that illustrates the process of adding and removing processing trays associated with optical lens orders in accordance with one embodiment. In accordance with one embodiment, when the system or application is initiated, the system requests and receives user input indicating the number of trays per stack. The system may also request and receive user input indicating the location of the oldest tray (e.g., lower left, upper left, upper right, lower right). Alternatively, the user may indicate the location of the newest tray in the stack sequence. Still, in certain embodiments, these variables may be preset.

Based on the above information, the process orient trays in a stacking sequence that emulates the order in which the operator will stack trays at the workstation. If the trays were previously scanned into the station, the process searches the database and display trays in the order which they are scanned into the station. Alternatively, the system may display the trays in real time while each processing tray is scanned at the processing station.

A non-limiting example of the stacking sequence at a particular processing station is illustrated in user interface 602. In the depicted embodiment, processing tray 123 was scanned first, 6585 second, etc. The next tray scanned into the station will be added above tray 3344 and a subsequent processing tray will begin a new stack.

User interface 604 depicts a new stacking sequence in response to determining that processing tray 5011 has been removed from the processing station. As can be seen, processing tray 1111 shifts downward in its respective stack as would be expected from the physical removal of processing tray 5011. All other processing trays within the stack sequence remain unchanged. Again, the updated sequence may be displayed in real time or updated at specific time intervals.

User interface 606 depicts the process of adding 2 more processing trays (7224 and 7225) to the current stack sequence indicated user interface 604. As illustrated, the process adds the 2 new trays according to the simple convention of stacking toward the right.

User interface 608 depicts a situation where the three trays in the left column are moved to a new station. Just as the user will have cleared that stack of trays from the table, the trays in the left column are cleared from the display and the remaining stacks shifts to the left to make room for more trays coming in from the right side of the sequence.

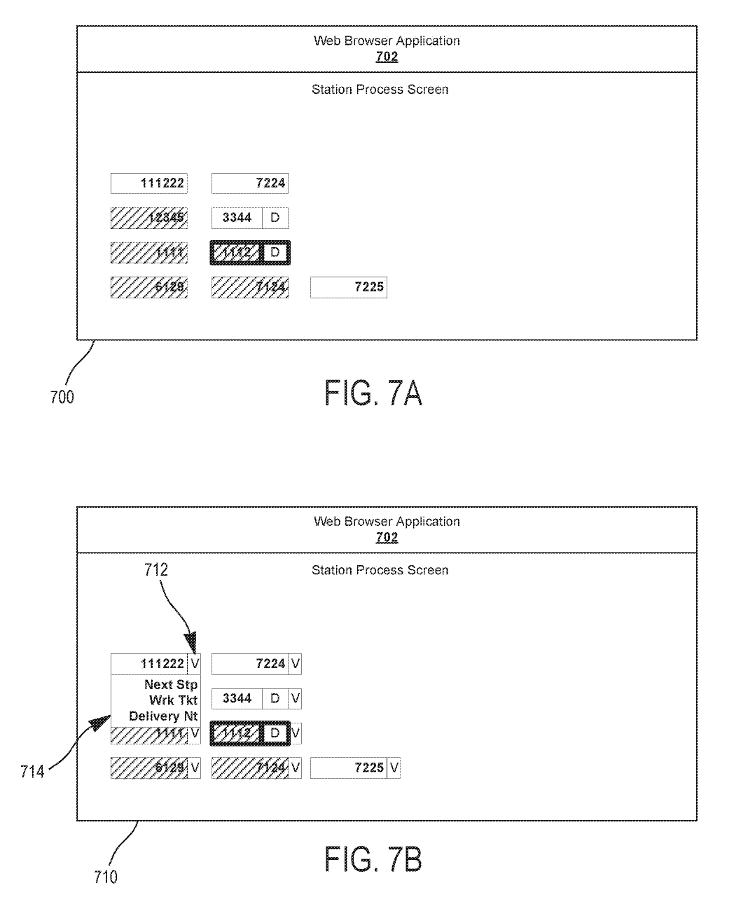

FIG. 7A is an image illustrating a user interface 700 for monitoring and displaying the status of optical lens orders in accordance with one embodiment. In the depicted embodiment, the user interface 700 is deployed using a web browser application 702 to access the system remotely over a private or public network. In the example embodiment, the trays are stacked 4 processing trays to a column. In the given example, trays that are red as indicated by hash lines are associated with lens orders that are late, while the white trays (no hash lines) are associated with lens orders that are currently on time. Additionally, the lens orders associated with tray 1112 is the most delayed lens order in comparison with the lens orders of the other trays. For instance, perhaps tray 1112 needed to be shipped 3 days ago, whereas trays 12345, 1111, 6129 and 7124 should have been shipped yesterday. As illustrated in FIG. 7A, in one embodiment, a prominent border is displayed around this processing tray. The lab technician should process the lens order for processing tray 1112 first prior to the others in this set of processing trays.

In addition, as illustrated in FIG. 7A, in one embodiment, user interface may include a visual indication to group one or more processing trays together. As an example, in the depicted embodiment, the user interface provides a visual indication that processing tray 1112 and processing tray 3344 will be processed next together at processing station D. Other types of visual indication for grouping may be used such as, but not limited to, placing a second border around grouped processing trays, making them larger or more prominent looking, or having connectors attached them together. The user can now process the two processing trays and transport them to the next station together to reduce processing time.

FIG. 7B is another image illustrating a user interface 710 for monitoring and displaying the status of optical lens orders in accordance with one embodiment. In this embodiment, the user interface may also include pull-down menu option 712. If the user selects the pull-down menu option 712, the system will present a list of options 714 related to the lens order associated with the particular processing tray. Non-limiting examples of options that may be available include enabling a user to view the next processing station for the processing tray, a work ticket associated with the lens order that includes the lens order and any special instructions, and a delivery note that contains shipping information. For example, in one embodiment, if the next stage in production is Edging and the step within that stage is Finish blocking, it would show Edging:Finish Blocking when you click on Next Step. In certain embodiments, administrators can also control the choices that are available on the drop-down listings for the trays. For example, some labs might prefer that their operators not see the delivery note.

Accordingly, the disclosed embodiments provide a technical solution to the problems associated with monitoring and updating the process of lens orders. In particular, the disclosed embodiments include a system and method of configuration to monitor the status of optical lens orders by performing, in no particular order, one or more of the following instructions: 1) associating a processing tray with an optical lens order; 2) receiving input indicating that the processing tray is at a first processing station; 3) electronically placing the processing tray in a sequence in one of a plurality of processing tray stacks, wherein the sequence emulates a physical stacking sequence of the plurality of processing tray stacks at the first processing station; 4) displaying the plurality of processing tray stacks in the sequence on a display; 5) determining a new sequence of the plurality of processing tray stacks at predetermined time intervals; 6) determining the new sequence of the plurality of processing tray stacks in response to receiving an indication that at least one processing tray within the plurality of processing tray stacks has been moved from the plurality of processing tray stacks; 7) displaying the plurality of processing tray stacks on the display according to the new sequence of the plurality of processing tray stacks, wherein the new sequence emulates a current physical stacking sequence of the plurality of processing tray stacks at the first processing station; 8) determining a first set of optical lens orders that have respectively exceeded an expected completion date for each optical lens order; 9) determining a first set of processing trays in the plurality of processing tray stacks corresponding to the first set of optical lens orders; 10) displaying in a first color the first set of processing trays in the plurality of processing tray stacks that correspond to the first set of optical lens orders that have respectively exceeded the expected completion date for each optical lens order; 11) determining a second set of optical lens orders that are respectively identified as being at risk for exceeding the expected completion date for each optical lens order; 12) determining a second set of processing trays in the plurality of processing tray stacks corresponding to the second set of optical lens orders; 13) displaying in a second color the second set of processing trays in the plurality of processing tray stacks that correspond to the second set of optical lens orders that are respectively identified as being at risk for exceeding the expected completion date for each optical lens order; and 14) generating a visual indication of a particular processing tray that should be processed first among the plurality of processing tray stacks at the first processing station, wherein the particular processing tray is a latest of the first set of optical lens orders that have respectively exceeded the expected completion date for each optical lens order.

Advantages of the disclosed embodiments include, but are not limited to, the following:

1) Efficiency: Labs will have a real-time visual indicator in one or more production station(s) for any job that changes status in the lab. This will improve consistency in meeting scheduled or promised delivery dates. More people in the lab will have this immediate visibility as opposed to an expeditor trying to find individual orders throughout the lab.

2) Consistency and improved turn-around time: Monitor screens will guide operators as to which job(s) should move at higher priority at any given station where today this can only be achieved by looking at individual papers for clues. This will improve turn-around times and help the lab retain contracted date-specific customer agreements.

3) Efficiency: Monitor screen allows mouse clicks to visualize the work ticket instead of physically removing from the tray, so far more efficient for the operator at the station.

4) Efficiency: The borders that group trays together will allow operators to gather multiple trays from one station to bring to another to improve efficiency and reduce number of trips from one station to another.

5) Contract retention/customer satisfaction: If many of these monitors are implemented the labs will essentially have expeditors at every monitored station to efficiently prioritize job flow to improve likelihood of meeting contracted and promised delivery dates.

6) Reduced training and errors: For example, the user interface provides clear direction on the next destination step for any given order at the station as opposed to learning visual clues about material types or coating types or coating codes printed on the paper work tickets.

The above disclosed embodiments have been presented for purposes of illustration and to enable one of ordinary skill in the art to practice the disclosed embodiments, but is not intended to be exhaustive or limited to the forms disclosed. Many insubstantial modifications and variations will be apparent to those of ordinary skill in the art without departing from the scope and spirit of the disclosure. For instance, although the flowcharts depict a serial process, some of the steps/blocks may be performed in parallel or out of sequence, or combined into a single step/block. The scope of the claims is intended to broadly cover the disclosed embodiments and any such modification.

For example, in certain embodiments, in addition to or in lieu of the visual color indicators, the processing trays may be configured with light emitting diodes (LED) of various colors and provide an actual visual indication of status or location using the physical light indicators on the processing trays themselves. Other types of physical visual indicators may also be employed on the processing trays such as, but not limited to, providing a display on each processing tray for displaying information regarding the status and location of lens orders.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

Additionally, although specific terms are employed herein, they are used in a generic and descriptive sense only and not for purposes of limitation. For instance, the term database, as used herein, is intended to include any form of organized data, including, but not limited to, data found in tables, charts, spreadsheets, and documents. Furthermore, the term database does not imply the use of a particular or specialized database software nor does it imply the use of any particular data structure.

1. A non transitory computer readable medium comprising instructions stored therein, which when executed by one or more processors, causes the one or more processors to perform operations comprising:
associating a processing tray with an optical lens order;
receiving input indicating that the processing tray is at a first processing station;
electronically placing the processing tray in a sequence in one of a plurality of processing tray stacks, wherein the sequence emulates a physical stacking sequence of the plurality of processing tray stacks at the first processing station;
displaying the plurality of processing tray stacks in the sequence on a display;
determining a new sequence of the plurality of processing tray stacks at predetermined time intervals;
determining the new sequence of the plurality of processing tray stacks in response to receiving an indication that at least one processing tray within the plurality of processing tray stacks has been moved from the plurality of processing tray stacks;
displaying the plurality of processing tray stacks on the display according to the new sequence of the plurality of processing tray stacks, wherein the new sequence emulates a current physical stacking sequence of the plurality of processing tray stacks at the first processing station;
determining a first set of optical lens orders that have respectively exceeded an expected completion date for each optical lens order;
determining a first set of processing trays in the plurality of processing tray stacks corresponding to the first set of optical lens orders;
displaying in a first color the first set of processing trays in the plurality of processing tray stacks that correspond to the first set of optical lens orders that have respectively exceeded the expected completion date for each optical lens order;
determining a second set of optical lens orders that are respectively identified as being at risk for exceeding the expected completion date for each optical lens order;
determining a second set of processing trays in the plurality of processing tray stacks corresponding to the second set of optical lens orders;
displaying in a second color the second set of processing trays in the plurality of processing tray stacks that correspond to the second set of optical lens orders that are respectively identified as being at risk for exceeding the expected completion date for each optical lens order; and
generating a visual indication of a particular processing tray that should be processed first among the plurality of processing tray stacks at the first processing station, wherein the particular processing tray is a latest of the first set of optical lens orders that have respectively exceeded the expected completion date for each optical lens order.

2. A system configured to monitor a status of optical lens orders, the system comprising:
memory for storing computer executable instructions and data; and
a processor for executing the computer executable instructions, wherein the computer executable instructions comprises instructions for:
associating a processing tray with an optical lens order;
receiving input indicating that the processing tray is at a first processing station;
electronically placing the processing tray in a sequence in one of a plurality of processing tray stacks, wherein the sequence emulates a physical stacking sequence of the plurality of processing tray stacks at the first processing station; and
displaying the plurality of processing tray stacks in the sequence on a display.

3. The system of claim 2, wherein the computer executable instructions further comprises instructions for:
determining a new sequence of the plurality of processing tray stacks in response to receiving an indication that at least one processing tray within the plurality of processing tray stacks has been moved from the plurality of processing tray stacks; and
displaying the plurality of processing tray stacks according to the new sequence of the plurality of processing tray stacks.

4. The system of claim 2, wherein the computer executable instructions further comprises instructions for:
determining whether at least one processing tray within the plurality of processing tray stacks has been moved from the plurality of processing tray stacks at predetermined time intervals;
determining a new sequence of the plurality of processing tray stacks in response to a determination that at least one processing tray within the plurality of processing tray stacks has been moved from the plurality of processing tray stacks; and
displaying the plurality of processing tray stacks according to the new sequence of the plurality of processing tray stacks.

5. The system of claim 2, wherein the computer executable instructions further comprises instructions for:
determining a first set of optical lens orders that have respectively exceeded an expected completion date for each optical lens order;
determining a first set of processing trays in the plurality of processing tray stacks corresponding to the first set of optical lens orders; and
displaying in a first color the first set of processing trays in the plurality of processing tray stacks that correspond to the first set of optical lens orders that have respectively exceeded the expected completion date for each optical lens order.

6. The system of claim 5, wherein the computer executable instructions further comprises instructions for:
determining a second set of optical lens orders that are respectively identified as being at risk for exceeding the expected completion date for each optical lens order;
determining a second set of processing trays in the plurality of processing tray stacks corresponding to the second set of optical lens orders; and
displaying in a second color the second set of processing trays in the plurality of processing tray stacks that correspond to the second set of optical lens orders that are respectively identified as being at risk for exceeding the expected completion date for each optical lens order.

7. The system of claim 5, wherein the computer executable instructions further comprises instructions for:
determining a second set of optical lens orders that are respectively identified as needing to be completed by an end of day;
determining a second set of processing trays in the plurality of processing tray stacks corresponding to the second set of optical lens orders; and
displaying in a second color the second set of processing trays in the plurality of processing tray stacks that correspond to the second set of optical lens orders that are respectively identified as needing to be completed by the end of day.

8. The system of claim 2, wherein the sequence is from lower left to upper right, wherein the lower left indicates a first tray in the plurality of processing tray stacks.

9. The system of claim 2, wherein receiving input indicating that the processing tray is at the first processing station is received using sensors on the processing tray.

10. The system of claim 2, wherein the sequence is user-selected.

11. The system of claim 2, wherein the computer executable instructions further comprises instructions for:
determining whether the processing tray belongs at the first processing station in response to receiving the input indicating that the processing tray is at the first processing station;
rejecting the processing tray at the first processing station in response to a determination that the processing tray does not belong at the first processing station; and
displaying a message indicating a correct processing station that the processing tray should be located.

12. The system of claim 5, wherein the computer executable instructions further comprises instructions for generating a visual indication of a particular processing tray that should be processed first among the plurality of processing tray stacks at the first processing station.

13. The system of claim 12, wherein the particular processing tray is a latest of the first set of optical lens orders that have respectively exceeded the expected completion date for each optical lens order.

14. The system of claim 2, wherein the computer executable instructions further comprises instructions for:
identifying a set of processing trays in the plurality of processing tray stacks that are to be processed at a common second processing station; and
providing a visual indication of the set of processing trays in the plurality of processing tray stacks that are to be processed at the common second processing station.

15. A computer-implemented method for monitoring a status of optical lens orders, the method comprising:
associating a processing tray with an optical lens order;
receiving input indicating that the processing tray is at a first processing station;
electronically placing, using a processor, the processing tray in a sequence in one of a plurality of processing tray stacks, wherein the sequence emulates a physical stacking sequence of the plurality of processing tray stacks at the first processing station; and
displaying, on a display, the plurality of processing tray stacks in the sequence.

16. The computer-implemented method of claim 15, further comprising:
determining a new sequence of the plurality of processing tray stacks in response to receiving an indication that at least one processing tray within the plurality of processing tray stacks has been moved from the plurality of processing tray stacks; and
displaying the plurality of processing tray stacks according to the new sequence of the plurality of processing tray stacks.

17. The computer-implemented method of claim 15, further comprising:
determining whether at least one processing tray within the plurality of processing tray stacks has been moved from the plurality of processing tray stacks at predetermined time intervals;
determining a new sequence of the plurality of processing tray stacks in response to a determination that at least one processing tray within the plurality of processing tray stacks has been moved from the plurality of processing tray stacks; and
displaying the plurality of processing tray stacks according to the new sequence of the plurality of processing tray stacks.

18. The computer-implemented method of claim 15, further comprising:
determining a first set of optical lens orders that have respectively exceeded an expected completion date for each optical lens order;
determining a first set of processing trays in the plurality of processing tray stacks corresponding to the first set of optical lens orders; and
displaying in a first color the first set of processing trays in the plurality of processing tray stacks that correspond to the first set of optical lens orders that have respectively exceeded the expected completion date for each optical lens order.

19. The computer-implemented method of claim 15, further comprising:
determining a second set of optical lens orders that are respectively identified as being at risk for exceeding the expected completion date for each optical lens order;
determining a second set of processing trays in the plurality of processing tray stacks corresponding to the second set of optical lens orders; and
displaying in a second color the second set of processing trays in the plurality of processing tray stacks that correspond to the second set of optical lens orders that are respectively identified as being at risk for exceeding the expected completion date for each optical lens order.

20. The computer-implemented method of claim 15, further comprising:
determining a second set of optical lens orders that are respectively identified as needing to be completed by an end of day;
determining a second set of processing trays in the plurality of processing tray stacks corresponding to the second set of optical lens orders; and
displaying in a second color the second set of processing trays in the plurality of processing tray stacks that correspond to the second set of optical lens orders that are respectively identified as needing to be completed by the end of day.
